(19) United States
(12) Patent Application Publication
(10) Pub. No.: US 2016/0055301 A1
(43) Pub. Date: Feb. 25, 2016

(54) SYSTEM AND METHOD OF MATCHING IDENTITIES AMONG DISPARATE PHYSICIAN RECORDS

(71) Applicant: TruthMD, LLC., Glendale, CA (US)

(72) Inventors: Gemma Turi-Cunningham, Laguna Beach, CA (US); Charles D. Rosen, Manhattan Beach, CA (US); Kourosh Maddahi, Beverly Hills, CA (US)

(21) Appl. No.: 14/832,865

(22) Filed: Aug. 21, 2015

Related U.S. Application Data
(60) Provisional application No. 62/040,300, filed on Aug. 21, 2014.

(51) Int. Cl. G06F 19/00

(52) U.S. Cl. CPC G06F 19/322

(57) ABSTRACT

Event records are matched to stored files in a master database. Each new event record is compared to entries in the stored files to determine whether a perfect match, a consistent match, or a fuzzy match is found. If so, the matches are evaluated to determine whether there's sufficient data to determine a record match. If so, the entries are checked to determine whether any contradictions exist. If no contradiction found, the entries are examined according to preset weights to determine the strength of the match. If the strength of the match surpasses a threshold, the entries are declared as matched.

### CROSS-REFERENCE TO RELATED APPLICATION

This application claims the benefit of priority from U.S. Provisional Patent Application Ser. No. 62/040,300, filed on Aug. 21, 2014, the entire disclosure of which is relied upon and incorporated herein by reference.

### BACKGROUND

1. Field

This disclosure relates to creation, management, and presentation of records relating to physicians.

2. Related Arts

Production of a professional background and status report for physicians requires the assembly and cross referencing of data records from multiple sources. Typically, these various sources do not carry consistent or reliable identifying characters that allow for unambiguous automated cross-references. A comprehensive status and background report for a physician is of high value to a number of potential users. Patients can make better-informed choices about selecting either a primary care physician or choosing a specialist for a particular condition. Malpractice insurance companies require the best information they can get for decisions about who to accept and how to set premiums. The quality of hiring decisions by hospitals and clinics is heavily dependent on the information available to them.

Although much information is available for the above use cases, either directly provided by physicians, state medical boards, or via the Internet, there are several problems with current data. The primary problem is that the relevant data is spread across thousands of web sites and this data is not cross-referenced (or “matched”). Beyond that, much of the available data is self-reported by physicians (or their assistants) and is not subject to verification and “data cleaning” by reporting entities. There is no standardization regarding such data and each state medical board has a different system and format for storing and reporting such data.

Despite the above, considerable information regarding various types of physicians exists, both in the public domain and from private sources. This data universe includes, among others, medical license status and license history with state medical boards; malpractice records; disciplinary actions; criminal convictions; and payments to physicians by pharmaceutical and medical device manufacturers. As mentioned above, the total number of unique data sources which could theoretically be consulted numbers in the thousands. State medical boards are perhaps the most basic and central source of such information, and there are sixty separate state medical boards for medical doctors and osteopathic physicians alone, each with their own distinct databases.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments of the invention described herein provide systems and methods of reliably cross referencing data records from different data sources and assembling a consolidated and comprehensive data set for generating a physician report. According to one embodiment, a master roster data set of doctors (MDs, Osteopaths, Chiropractors, etc.) is maintained. The master roster has been standardized and normalized according to industry standard database conventions. When a record of a new data set is received, it needs to be cross-referenced with the master. This new data set could be a set of, e.g., malpractice cases, disciplinary actions, industry payments, etc. The required data processing action is to analyze each record in the new data set and find a match in the “master” data set.

According to one embodiment, the process will separate the new records into two result sets. One result set will be successfully cross matched, and each new record will be associated with an “Identifying Key” to link it with the “master” roster data set. Those new records which could not be successfully cross matched using the process are placed in an “unmatched bucket” for further manual review. These unmatched records will receive further research to determine if they can be matched up or must be discarded as not useable due to insufficient identifying attributes.

### BRIEF DESCRIPTION OF THE DRAWINGS

Other aspects and features of the invention would be apparent from the detailed description, which is made with reference to the following drawings. It should be appreciated that the detailed description and the drawings provides various non-limiting examples of various embodiments of the invention, which is defined by the appended claims.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic of system architecture according to an embodiment of the invention.

FIG. 2 is a schematic of system overview according to an embodiment of the invention.

FIG. 3 is a flow chart of an exemplary process according to an embodiment of the invention.

FIG. 4 is a schematic of system architecture according to an embodiment of the invention.

### DETAILED DESCRIPTION

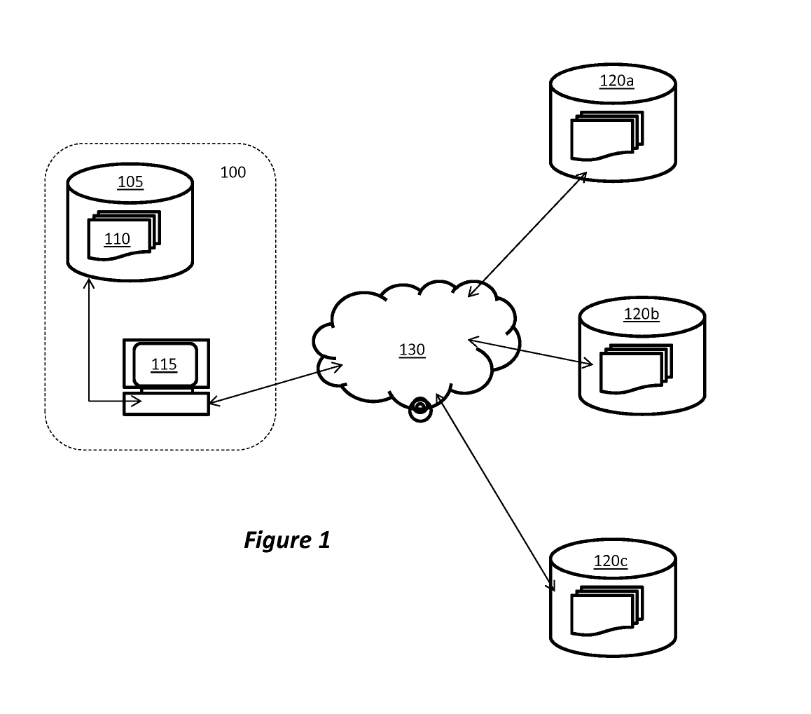

Embodiments of the invention create, maintain and update data records for physicians. FIG. 1 illustrates schematic of the system architecture. As shown in FIG. 1, the system 100 comprises a master database 105, which stores records 110 of individual physicians. A processor, such as a computer 115, maintains the database and enables inquiries and searches of records 110 within the master database 105. The processor 115 obtains new entries from multiple databases 120a-120c, via the network 130, e.g., the Internet. Any of databases 120a-120c may be a private database, a public database, a governmental database, etc. According to some embodiments, private databases may be, e.g., databases of records maintained by insurance companies with records of claims and payments. According to some embodiments, public databases may be, e.g., databases of records maintained by trade associations, with records of registered practitioners, disciplinary actions, etc. According to some embodiments, governmental databases may be, e.g., databases of records maintained by local, regional, and/or federal government with records of criminal cases, Medicare cases, etc.

In the embodiment of FIG. 1, the entries in each of the records 110 are maintained according to a predetermined convention, to ensure their integrity and accessibility (e.g., by search engines). However, it should be appreciated that the entries in any of databases 120a-120c may be maintained according to a different convention, and their integrity may be questionable. For example, while the entries 110 may include full middle name, some databases may only include first initial of middle name and some may not include middle name at all. Similarly, entries 110 may include full social security number (SSN), while other databases may have only last four digits, may omit SSN altogether, or include a membership number instead of a SSN. Thus, it is not simple to automatically match and/or incorporate data from any of databases 120a-120c into the entries 110 of master database 105.

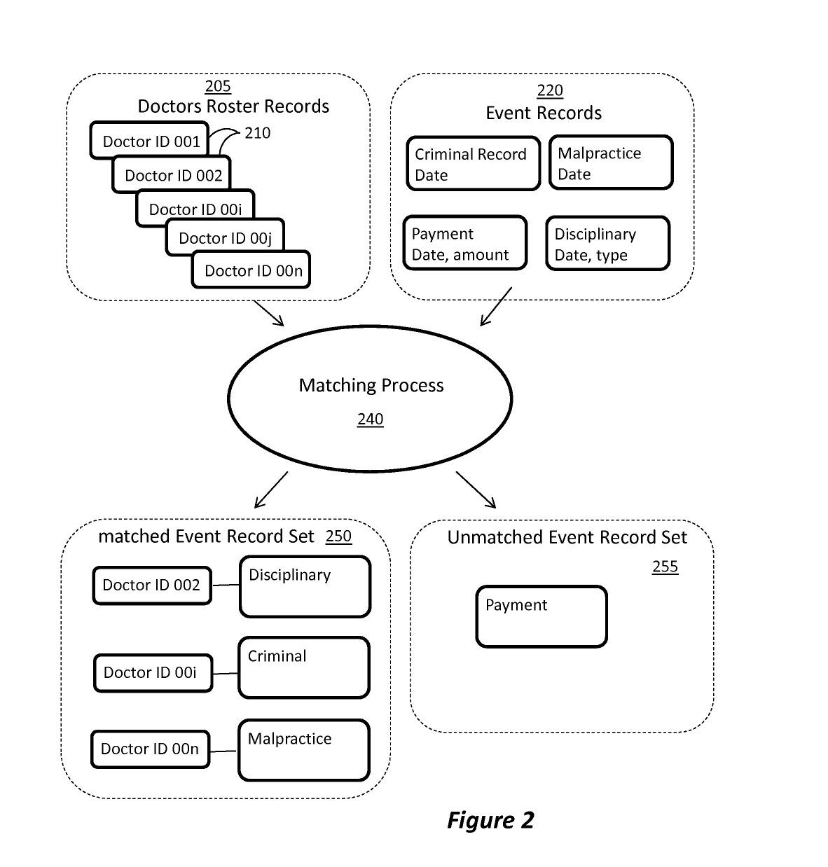

FIG. 2 illustrates an overview of an embodiment of the invention. A master database 205 stores plurality of records 210, indicated as Doctor ID 001-Doctor ID00n. A plurality of event records 220 are stored in various databases, such as databases 120a-120c of FIG. 1. Each of the event records may be in a different format and may or may not correspond to one of the physicians having a record in the master database 205. A matching process is performed by a processor, such as processor 115 of FIG. 1, to determine whether any of the event records 220 belongs to any of the physicians records Doctor ID001-Doctor ID00n. The process compiles two record sets from the matching process: a matched event record set 250 and an unmatched event records set 255. The matched event record set 250 may be used to update the entries in the master database 205, while the unmatched even record set 255 may need further processing or may be discarded.

For each of the above sources, there will be some unique record (vector) of information provided. As a typical example, the identifying information coming from a state medical board might include the following:

### License Number

### Last Name

### First Name

Middle Name (or initial)

### Name Suffix

### Address

### City

### State

### Zip Code

### Birth Year

### Birth Date

### Gender

### Doctor Type (MD, DO, DPM, DC, etc.)

### Medical School

### Graduation Year

### Medical Specialty

Not all of the above items are provided by every state or data source. Some provide more, some less. In the case of some data sources, the only identifying information will be name fields and a city and state. However, each event record must be matched against one of the entries in the master database. The matching is done by the matching process 240. On a pure mathematical level, the problem addressed by matching process 240 is one of comparing two vectors of attributes, both assumed to be for a doctor.
Doctor Record 1 (a1, b1, c1, . . . n1)
Doctor Record2 (a2, b2, c2, . . . n2)

Wherein any of a1, b1, c1, . . . n1 and a2, b2, c2, . . . n2 may take on any values corresponding to any of the items listed above or other attributes not listed.

In applying matching process 240, each attribute is compared against the corresponding attribute in the other vector, using distinct decision rules and weighting associated with each attribute. In the typical case, one or more of the attributes may be null (e.g., a particular record may not list SSN). Each of the attributes (a, b, c, etc.) has differing relative importance. Embodiments of the invention include original decision rules and weighting for each attribute, so as to determine whether each event record belongs to the matched event record set or to the unmatched event record set.

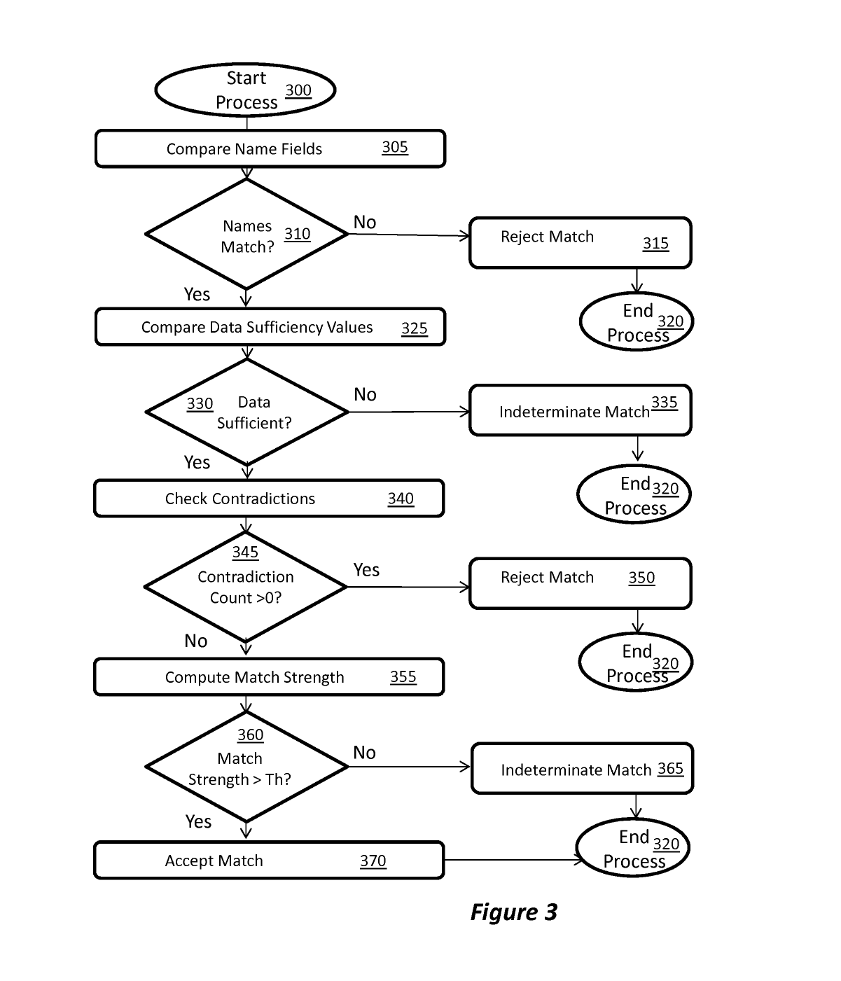

Beneficial features of the embodiments will now be described in more details, with reference to FIG. 3. Prior to performing the process illustrated in FIG. 3, three string matching functions are defined, each with two string arguments:
Perfect Match Boolean PM(String1, String2)
Consistent Match Boolean CM(String1, String2)
Fuzzy Match real FM(String1, String2)

To be sure, in this respect, “Boolean” represents the Boolean data type having only two values: true and false. The “Perfect Match” function, “PM”, returns true if and only if String1 and String2 are exactly the same, having the same number of characters and the exact same characters in the same sequence. For example, Boolean PM(Smith,Smithe) will return false.

The “Consistent Match” function, “CM”, returns true if any characters present in String1 match the corresponding character String2 and vice versa. The two strings may have different lengths, but any characters present must match. The typical situation here is when one doctor record has a single initial for the value of “middle_name”, while the other doctor record contains the complete middle name. As long as the initial provided in the first string matches the first character of the second string, then the function returns true. As another example, Boolean CM(Smith,Smithe) will return true, since all of the letters in String 1: s, m, i, t, h, appear in both strings.

The “Fuzzy Match” function provides a facility to identify matches where one string may have an error but there is still a “close enough” match for the entity attributes presented to represent a valid match. Essentially, it is a method to accommodate “noise” in the data without automatically rejecting what is otherwise a valid match between two doctor records. The “FM” function returns a value between 0 and 1, reflecting the degree of consistency between String1 and String2. A value of 1 would only be returned in the case of a perfect match. A value of zero means that there are no characters in common between the two strings. A value between zero and one would mean that there are characters in common between the two strings, but they do not perfectly match. For example, FM(Smith,Smyth) will return a value higher than zero but less than 1.

According to some embodiments, a further “Uniqueness” function is defined and is called “Attribute Uniqueness” or “AU”. This may be implemented as a table driven “lookup” function, which reflects the frequency with which a specific attribute value appears in the full universe of doctor data. For example, a last name of “Smith” or “Johnson” would have a comparatively lower “AU” value than the name “Dickens”. This function is used to assign different weights to matching attributes when making the final determination of a match. The AU function returns a value between 0 and 1. A value of 1 would indicate that the value is completely unique within the data universe under consideration. Lesser values of AU indicate that the data value is more common. A value of 0 would not occur in practice, but in the theoretical case would mean that all entities have the same attribute value and thus there is no uniqueness present at all in the data. Such an attribute would not be a useful comparative.

According to one embodiment, the mathematical representation of the uniqueness function is as follows.
Attribute Uniqueness real AU(Attribute,Value)

Below is a sample of the uniqueness function data for the “LAST NAME” attribute. Each major attribute will have a similar empirically determined and table driven uniqueness function.

| Name | Frequency | AU Value |
|---|---|---|
| Abadir | 1 | 1 |
| Aballay | 1 | 1 |
| Abalos | 1 | 1 |
| Doeren | 2 | 0.5 |
| Doerffler | 2 | 0.5 |
| Doers | 2 | 0.5 |
| Einck | 3 | 0.33 |
| Einisman | 3 | 0.33 |
| Einreinhofer | 3 | 0.33 |
| Zimmerman | 504 | 0.00198 |
| Turner | 996 | 0.00100 |
| Nelson | 1725 | 0.00058 |
| Johnson | 5324 | 0.00019 |
| Smith | 7373 | 0.00014 |

As can be seen from the above example, the more the name is unique within the master database, the more the value will be closer to 1. Conversely, the more the attribute is common within the master database, the closer the value is to zero.

According to a further embodiment, an “Attribute Completeness” function is defined and is called “AC”, which returns a Boolean value. This checks to see if both doctor records contain a non-null value for a particular attribute.
Attribute Completeness Boolean AC(String1, String2)

According to yet a further embodiment, an “Attribute Weight” function is defined and is called “AW” which returns a real value indicating the relative weight or contributive value a particular attribute match has for validating the match.
Attribute Weight real AW(Attribute,Value)

FIG. 3 provides a flow chart of a process according to an embodiment utilizing the above functions. The goal of the process is, given two doctor records, with a set of possible attributes defined above, determine if these two records refer to the same physician. It is important to note that the typical situation is one in which several of the attributes are missing and there may be errors in the data. Therefore, in this embodiment, the process has three possible results for each comparison made:
Reject Match
Confirm Match
Indeterminate Match

In one embodiment, only the data from a confirmed match would be used to update the master database. The details of the process are described in the following:

With reference to FIG. 3, the process starts at step 300 and proceeds to the name comparison step 305. In the comparison decision 310, when the consistent match comparison of the name returns false and the fuzzy match returns a value below a set threshold, t_fm, the process rejects the match at 315 and terminates at 320. In this example, the attribute completeness function is utilized when comparing the middle name. In this case, when the attribute completeness returns true, it means that both records include a middle name for the doctor. Therefore, the entries for middle name are compared and if consistent match is false and fuzzy match returns a value below the threshold at 310, the match is rejected at 315 and ends at 320. The following are examples of name comparison process 310.

1) Compare last_name1 to last_name2
IF CM(last_name1, last_name2)=FALSE AND
   FM(last_name1, last_name2)<t_fm_last_name THEN Reject Match
      2) Compare first_name1 to first_name2
IF CM(first_name1, first_name2)=FALSE AND
   FM(first_name1, first_name2)<t_fm_first_name THEN Reject Match
      3) Compare middle_name1 to middle_name2
IF AC(middle_name1, middle_name2)=TRUE AND
   CM(middle_name1, middle_name2)=FALSE AND
   FM(middle_name1, middle_name2)<t_fm_middle_name
THEN Reject Match (END PROCESS)

If it is determined that the names match at 310, then the process proceeds to 325 to evaluate data sufficiency. This step is performed in order to determine whether there is enough data to confirm a match, by summing “Attribute Completeness” for each of the indicated attributes, and applying a “sufficiency weight.” For this process, an additive counter is used, called data_sufficiency_value, wherein at the start of the process the counter is reset to zero and at each step the counter is incremented according to a prescribed amount. The prescribed amount (weight) may differ at each step depending on the entry evaluated. The process proceeds as follows:

At step 325 set data_sufficiency_value=0, and then perform:
IF AC(middle_name1, middle_name2)=TRUE
THEN data_sufficiency_value=middleNameSufficiencyWeight
IF AC(birth_year1, birth_year2)=TRUE
THEN data_sufficiency_value=data_sufficiency_value+birthYearSufficiencyWeight
IF AC(birth_date1, birth_date2)=TRUE
THEN data_sufficiency_value=data_sufficiency_value+birthDateSufficiencyWeight
IF AC(address1, address2)=TRUE
THEN data_sufficiency_value=data_sufficiency_value+address SufficiencyWeight
IF AC(city1, city2)=TRUE AND AC(state1, state2)=TRUE
THEN data_sufficiency_value=data_sufficiency_value+cityStateSufficiencyWeight
IF AC(medical_school1, medical_school2)=TRUE
THEN data_sufficiency_value=data_sufficiency_value+medicalSchoolSufficiencyWeight
IF AC(graduation_year1, graduation_year2)=TRUE
THEN data_sufficiency_value=data_sufficiency_value+graduation_yearSufficiencyWeight
IF AC(specialty1, specialty2)=TRUE
THEN data_sufficiency_value=data_sufficiency_value+specialtySufficiencyWeight
   At step 330 compare the resulting data_sufficiency_value to a threshold. The Sufficient_Data_Threshold is a constant threshold value, below which it is considered that there is insufficient information to assign a match with confidence.
IF (data_sufficiency_value<Sufficient_Data_Threshold)
THEN Indeterminate Match at step 335 and end the process at step 320.

When the data_sufficiency_value is accepted at step 330, the process proceeds to step 340 to check for contradictions. The contradiction is also performed using a counter, which is reset at step 340:
Contradiction_Count=0

The process at 340 then increments the contradiction counter as follows:
if AC(name_suffix1,name_suffix2)=TRUE AND
   name_suffix1≠name_suffix2
THEN Contradiction_Count=Contradiction_Count+1
if AC(gender1,gender2)=TRUE AND
   gender1≠gender2
THEN Contradiction_Count=Contradiction_Count+1
if AC(doctorType1, doctorType 2)=TRUE AND
   doctorType1≠doctorType2
THEN Contradiction_Count=Contradiction_Count+1

In step 345 the contradiction count is compared to a set threshold, which in this example is zero. Thus at step 345, if Contradiction_Count>0

THEN Reject Match at 350 and terminate the process at 320.

On the other hand, if the contradiction count is below the threshold, i.e, in this example if the contradiction count is zero, then the process proceeds to step 355 to compute a match strength. The match strength may be computed over one or more matching arguments, using attribute uniqueness. Examples are as follows.

### Compute Name Match Strength

name_match_strength=FM(last_name1, last_name2)*AU(“LAST_NAME”,last_name1)+FM(first_name1, last_name2)*AU(“FIRST_NAME”,first_name1)+FM(middle_name1, middle_name2)*AU(“MIDDLE_NAME”,first_name1)

### Compute Birth Date and Birth Year Match Strength

birth_year_match_strength=0
IF AC(birth_date1, birth_date2)=FALSE AND
   AC(birth_year1, birth_year2)=TRUE AND
   PM(birth_year1, birth_year2)=TRUE
THEN
   birth_year_match_strength=AW(“BIRTH_YEAR”)
birth_date_match_strength=0
IF AC(birth_date1, birth_date2)=TRUE AND
   PM(birth_date1, birth_date2)=TRUE
THEN
   birth_date_match_strength=AW(“BIRTH_DATE”)

### Compute City and State Match Strength

IF AC(city1, city2)=TRUE AND AC(state1, state2)=TRUE AND PM(state1,state2)
THEN
city_state_match_strength=FM(city1, city2)*AU(“CITY”, city1)*AW(“CITY”)

### Compute Address Match Strength

address_match_strength=0
IF AC(address1, address2)=TRUE
THEN
address_match_strength=FM(address1, address2)*AU(“ADDRESS”, address1)*AW(“ADDRESS”)

### Compute Medical School Match Strength

medical_school_match_strength=0
IF AC(medical_school1, medical_school2)=TRUE
THEN
medical_school_match_strength=FM(medical_school1, medical_school2)*AU(“MEDICAL_SCHOOL”, medical_school1)*AW(“MEDICAL_SCHOOL”)

### Compute Specialty Match Strength

specialty_match_strength=0
IF AC(specialty1, specialty2)=TRUE AND PM(specialty1, specialty2)=TRUE
THEN
specialty_match_strength=AU(“SPECIALTY”,specialty1)*AW(“SPECIALTY”)

### Compute Total Match Strength

total_match_strength=name_match_strength*AW(“NAME”)+
birth_year_match_strength+
birth_date_match_strength+
address_match_strength+
city_state_match_strength+
medical_school_match_strength+
specialty_match_strength

Then in step 360 a Final Match Determination Decision Rule is implemented to determine whether to accept the match. A match strength threshold is set, below which a match will not be accepted.
In step 360, if (total_match_strength>=Confirm_Match_Threshold)
THEN Confirm Match at step 370.
ELSE Indeterminate Match at step 365.

Confirm_Match_Threshold is a constant value whereby any total_match_strength above this level is determined to have sufficient force to automatically confirm a match.

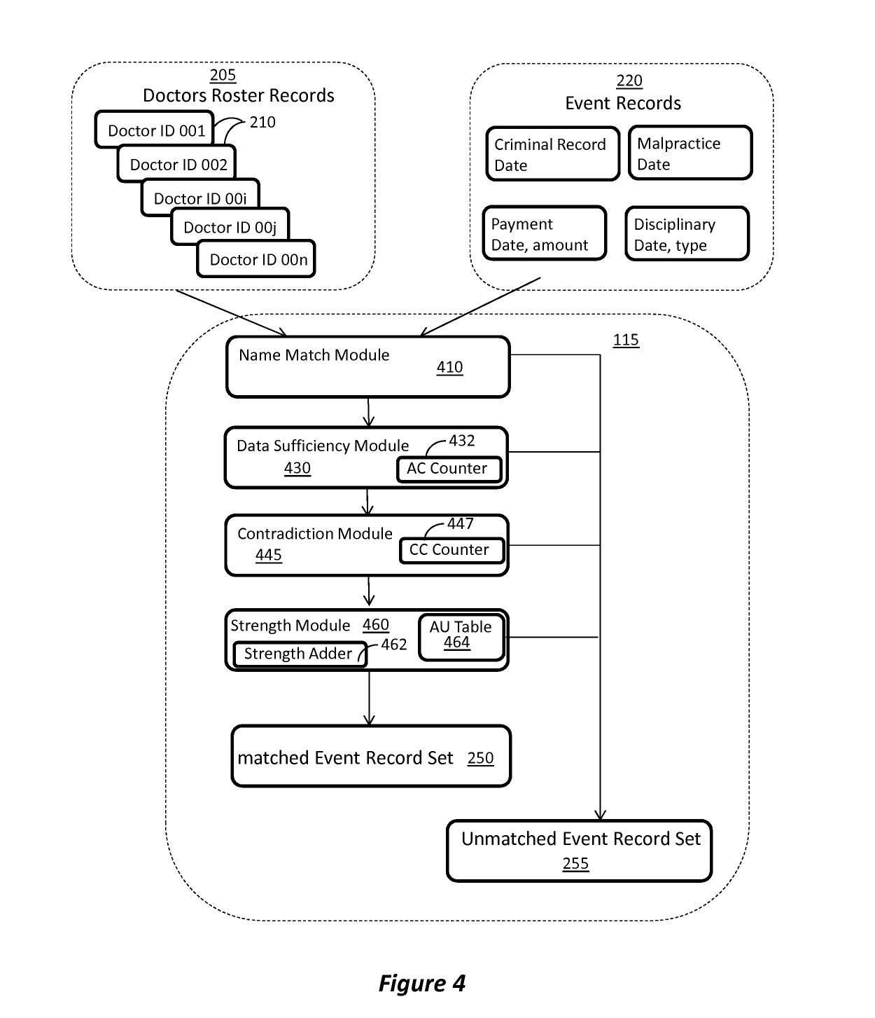

FIG. 4 is a schematic of system architecture according to an embodiment of the invention. In FIG. 4, an event record is fetched from event record 220 and an attempt is made to match it to one of the records in the master database 205. The event record may be obtained using a web crawler, by an API, by a “push” function, or any other generally known means. The fetching may or may not be part of the processor 115. Once the record is obtained, the modules of processor 115 are activated to attempt to match the event record to one of the doctors' records. This process starts with a high-level filter, which in this example is the name match module 410. Of course, other fields may be used for the high-level filter, with the idea that if the match fails at this high-level filter stage, there is no reason to continue the process on this particular event record.

The name match module 410 attempts to match the last, first and middle names using the Perfect Match, Consistent Match and, Fuzzy Match functions. If no match is found, there's no reason to proceed and the event record is marked as unmatched, and may be stored in the unmatched event record set 255. Conversely, if a match is found, the data sufficiency module 430 operates to determine whether the match has sufficient data to merit continuing the process. The data sufficiency module 430 incorporates an Attribute Completeness counter which adds the number of “true” results obtained for each of the fields in the high-level filter. For example, if both event record and doctor record include a first, middle and last name, the AC will show the value 3. Conversely, if one of the records omits middle name, the AC counter will show the value 2. The AC counter value is then compared to a sufficiency threshold and, if it passes, the process would proceed to the contradiction module. Otherwise, the event record is marked as unmatched, and may be stored in the unmatched event record set 255.

The contradiction module 445 is employed to filter out event records that may have sufficient data matching, but may have an unacceptable level of contradictory entries. The contradiction module employs a contradiction counter 447, which is incremented for each string that returns true on attribute completeness, but the attributes in the event record and doctor record do not match. For example, it is common to have first and last name repeated within a family, and use a name suffix to distinguish among generations, e.g., George Smith, George Smith Jr., George Smith 3^{rd}, etc. Thus, if the check of name suffix returns a contradiction, it may mean that the records refer to a different person, so the contradiction counter is incremented. Similarly, the name may be the same, but the state may be different, suggesting that the records refer to a different person. Thus, if the contradiction counter is above a set contradiction threshold, the event record is marked as unmatched, and may be stored in the unmatched event record set 255. To limit the matching to exact match, the contradiction threshold may be set to zero.

Finally, a strength module 460 is employed to determine the quality of the match. The strength module 460 incorporates an attribute uniqueness sub-module 464, which in this example is a look-up table. However, other methods may be employed to generate the AU sub-module 464, for example, it may be calculated on the fly for each comparison. In one example, the AU value of each entry is the inverse of the total number of identical entries in the master database. Thus, if the attribute is “Turner” the AU module may refer to the look-up table, such as the table shown above, and fetch the value 0.001. Conversely, the AU module may on the fly add the number of records having the entry “turner” and then take the inverse. In the above example there are 996 entries of the name Turner, such that 1/996=0.001.

Embodiments of the invention can be applied to other fields of endeavor such as attorneys, other health care professionals, or other clearly definable entities with a finite and obtainable set of attributes. The following is a concrete example of such an embodiment in the field of cross referencing data about “missing children.” We define a vector of attributes having the following structure.

Child Attribute Vector: (Last Name, First Name, Middle Name, Name Suffix, Address, City, State, Zip code, Birth Date, Gender, Disappearance Date, Height, Weight, Hair Color, Eye Color, Ethnicity).

Various state and local databases of missing children and children under social service guardianship could be cross-referenced using the invention, with appropriate “weighting” and “sufficiency” values developed empirically to be appropriate for this data universe.

While the invention has been described with reference to particular embodiments thereof, it is not limited to those embodiments. Specifically, various variations and modifications may be implemented by those of ordinary skill in the art without departing from the invention's spirit and scope, as defined by the appended claims. Additionally, in order to assist in distinguishing entries in the doctors records and entries in the event records, the terms “entry,” “argument” and “attribute” may be used interchangeably, depending on the context.

1. A computerized implemented method for maintaining database entries, comprising:
maintaining a master database having a plurality of records, each records comprising a plurality of entries;
receiving an event report having a plurality of arguments, and performing a process to determine whether the event report corresponds to any of the records by performing the steps:
defining three match types comprising a perfect match (PM), a consistent match (CM) and a fuzzy match (FM), wherein PM is a Boolean function returning true only if an entry and an argument have same number of characters in the same sequence, CM is a Boolean function returning true only when any characters present in an argument matches a character present in an entry; and FM is a function assigning a value from zero to one reflecting degree of consistency between an entry and an argument;
storing a fuzzy match threshold;
comparing an argument to an entry and, when a consistent match returns true, storing a match indicia, and when a consistent match returns false and FM returns a value below the fuzzy match threshold, storing unmatch indicia.

2. The method of claim 1, further comprising establishing a data sufficiency counter and data sufficiency threshold, and incrementing the data sufficiency counter upon each determination that an entry in a record corresponds to an argument in the report, and thereafter comparing the data sufficiency counter value to the data sufficiency threshold and rejecting a match when the data sufficiency counter value is below the data sufficiency threshold.

3. The method of claim 2, further comprising storing an undetermined match indicia whenever the data sufficiency counter value is below the data sufficiency threshold.

4. The method of claim 2, further comprising establishing a contradiction counter and incrementing the contradiction counter each time an argument does not match a corresponding entry of a record, and rejecting a match whenever the contradiction counter value surpasses a contradiction threshold.

5. The method of claim 4, wherein the contradiction threshold is set to zero.

6. The method of claim 4, further comprising assigning a weight to each type of the entries and applying a corresponding weight to each match indicia and determining whether total weight exceeds a match strength threshold.

7. The method of claim 6, further comprising storing an undetermined match indicia whenever the total weight fails to exceed a match strength threshold.

8. A method for determining a match between a first file having a plurality of first entries and a second file having a plurality of second entries, comprising:
for each of the second entries determining whether there is a match to one of the first entries;
assigning values to each match and determining whether a sum of the values exceeds a sufficiency threshold;
for each of the second entries determining whether there is a contradiction with one of the first entries and determining whether number of contradictions is below a contradiction threshold;
assigning match strength to each match and determining whether a sum of the match strengths exceeds a strength threshold;
confirming a match only when the sum of the values exceeds a sufficiency threshold and number of contradictions is below a contradiction threshold and the sum of the match strengths exceeds a strength threshold;
whenever a match is confirmed, updating the first file using the second entries of the second file.

9. The method of claim 8, wherein assigning match strength comprises: for each of the second entries, fetching an assigned value from a look-up table.

10. The method of claim 8, wherein assigning match strength comprises: for each of the second entries, interrogating a master database to determine a sum of total identical entries in the master database that are identical to the second entry, and calculating an inverse of the sum of total identical entries.

11. A system for maintaining a roster of doctors records, comprising:
a storage storing a master database comprising a plurality of doctors records, each doctor record corresponding to a single doctor and comprising a plurality of entries;
a processor receiving event records and processing each event record to determine whether it matches one of the records, wherein each of the event records comprises a plurality of arguments;
wherein the processor comprises:
a high-level filter operating on a preselected subset of the arguments and determining whether the preselected subset of the arguments match corresponding entries in one of the records;
a data sufficiency module operating on a preselected second subset of the arguments and determining whether a sufficient number of the preselected second subset of the arguments match corresponding entries in one of the records;
a contradiction module operating on the arguments to determine whether a number of contradictions existing between arguments and corresponding entries exceeds a contradiction threshold; and,
a match strength module adding weights assigned to each of the arguments.

12. The system of claim 11, wherein the high-level filter comprises three functions consisting of: a perfect match Boolean function, a consistent match Boolean function, and a fuzzy match real function returning a value between zero and one.

13. The system of claim 12, wherein the perfect match Boolean function is configured to return true only when an argument of an event record and an entry of a doctor record have same number of characters and exact same characters in same sequence.

14. The system of claim 13, wherein the consistent match Boolean function is configured to return true only when any characters present in an event record match the corresponding characters in a doctor record and vice versa.

15. The system of claim 11, wherein the data sufficiency module comprises an attribute completeness counter that is configured to be reset to zero prior to matching of a new event record, and which is configured to increment each time both the doctor record and the event record contain a non-null value for a particular entry and corresponding argument.

16. The system of claim 11, wherein the contradiction module comprises a contradiction counter that is configured to be reset to zero prior to matching of a new event record, and which is configured to increment each time that an argument in the event record contradicts an entry in the doctor record.

17. The system of claim 11, wherein the strength module comprises a strength determination sub-module and a strength adder sub-module.

18. The system of claim 17, wherein the strength determination sub-module comprises a look-up table having weight value assigned to each entry in the master database.

19. The system of claim 17, wherein the strength determination sub-module comprises a function configured to interrogate the master database to determine a sum of total identical entries in the master database that are identical to the argument, and calculating an inverse of the sum of total identical entries.

20. The system of claim 17, wherein the strength adder sums total weights issued by the strength determination sub-module.
